(19) United States
(12) Patent Application Publication
(10) Pub. No.: US 2014/0326090 A1
(43) Pub. Date: Nov. 6, 2014

(54) METHOD FOR PRODUCING A THREADED PART AS COMPOSITE COMPONENT, ROLLER SCREW DRIVE, LINEAR ACTUATOR, AND ELECTROMECHANICAL BRAKE BOOSTER HAVING SUCH A COMPOSITE COMPONENT

(71) Applicants: Ugur Kisa, Immenstadt (DE); Bernd Groll, Oberstdorf (DE); Martin Kirschner, Blaichach (DE); Marc Zimmermann, Sonthofen (DE); Harald Guggenmos, Immenstadt/Seifen (DE); Tobias Rasch, Maierhoefen (DE); Arndt Bauer, Kempten (DE)

(72) Inventors: Ugur Kisa, Immenstadt (DE); Bernd Groll, Oberstdorf (DE); Martin Kirschner, Blaichach (DE); Marc Zimmermann, Sonthofen (DE); Harald Guggenmos, Immenstadt/Seifen (DE); Tobias Rasch, Maierhoefen (DE); Arndt Bauer, Kempten (DE)

(73) Assignee: ROBERT BOSCH GmbH, Stuttgart (DE)

(21) Appl. No.: 14/342,325

(22) PCT Filed: Jul. 5, 2012
(86) PCT No.: PCT/EP2012/063081

§ 371 Date: Jul. 28, 2014

(30) Foreign Application Priority Data
Sep. 1, 2011 (DE) 10 2011 081 966.5

(51) Int. Cl. F16H 25/22; B21D 15/04; B21D 39/00; B21D 53/10; B21D 53/24

(52) U.S. Cl. CPC F16H 25/2204; B21D 53/10; B21D 53/24; B21D 39/00; B21D 15/04
USPC 74/89.23; 29/456

(57) ABSTRACT

An electromechanical brake booster includes a hollow spindle and a hollow screw. Courses of thread are produced by deformation from metal and extrusion-coating them together with tubular supporting structures made of plastic. The hollow spindle and the hollow screw are produced as composite components.

### CROSS REFERENCE TO RELATED APPLICATION

The present application is the national stage entry of International Patent Application No. PCT/EP2012/063081, filed on Jul. 5, 2012, which claims priority to Application No. DE 10 2011 081 966.5, filed in the Federal Republic of Germany on Sep. 1, 2011.

### FIELD OF INVENTION

The present invention is based on a method for producing a threaded part as composite component. A threaded part is meant to denote a part provided with a screw thread. In particular, a threaded part denotes a spindle, a screw and/or a nut. The thread may have one or more course(s) of thread. The threaded part is provided as lead screw, in particular. In addition, the present invention relates to a ball screw drive, the spindle and/or nut of the ball screw drive being produced by the method according to the invention. The present invention also relates to a linear actuator and an electromechanical brake booster provided with such a ball screw drive.

### BACKGROUND INFORMATION

German Application No. DE 10 2009 045 857 describes a spindle for a ball screw drive, which has a metal pipe as supporting structure for a course of thread. A spiral-shaped metal strip having a rectangular cross section is applied on the metal pipe as course of thread, and the metal pipe is integrally formed on a foot region of the spiral-shaped metal strip by applying high hydraulic pressure from the inside. This produces a keyed connection in the axial direction between the spiral-shaped metal strip and the pipe forming a supporting structure of the spindle. A supporting structure in this case is a component which imparts mechanical stability to the course of thread, or which increases the mechanical stability of the course of thread. The metal strip bent in the form of a spiral and having a rectangular cross-section forms the course of thread of the threaded part which, in accordance with the cross-section of the metal strip, has a rectangular thread cross-section. The course of thread and the tubular support element constitute the threaded part, which is produced as composite component. The connection is accomplished by premolding the tubular supporting structure onto the foot region of the course of thread, i.e., by deforming the supporting structure through the application of high pressure on the metal part from the inside.

### SUMMARY

The method according to the present invention provides for the production of a threaded part as composite component featuring a course of thread and a tubular supporting structure. The course of thread is produced by deformation. According to the present invention, the tubular supporting structure is produced by primary shaping, and the primary shaping at the same time also joins the supporting structure and the course of thread. The connection takes the form of an integral and/or keyed connection. The supporting structure, for example, is able to be produced from metal or plastic in a casting process; for the casting, the course of thread is inserted into a casting tool and possibly forms part of a casting tool. The supporting structure is produced by die casting using metal, or by injection molding using plastic. The term primary shaping encompasses all manufacturing methods that produce a solid body from an amorphous material. Primary shaping gives a solid body its first shape. Materials suitable for primary shaping may be in liquid, gaseous, granulated or powder form, for example.

The course of thread may have multiple threads, i.e., more than one course of thread. Because the supporting structure provides the course of thread with mechanical stability, the course of thread is able to be produced from a thin-walled material that is easily deformed. It is possible to produce the course of thread from a tube or strip, using a deforming process. The course of thread is preferably made of metal. One advantage of the present invention is that the course of thread can be produced from a wear-resistant material, and the supporting structure from a cost-effective material. Additional advantages of the present invention are the economical producibility of the threaded part and the ability to produce complex shapes. The statements above are of merely exemplary character and not fully inclusive.

In the case of a spindle or, in general, a threaded part having an external thread, the supporting structure may be of solid material. The present invention also provides for a tubular supporting structure, in which the course of thread may be situated on the outside or inside. The tubular development reduces the weight and saves material. In addition to a nut or a spindle having an external thread, the tubular design of the supporting structure allows it to be produced in tubular form as a hollow spindle provided with an internal thread.

The present invention also provides for the production of a track for rolling elements by deformation into a course of thread. For example, the course of thread has a spiral-shaped groove as track for the rollers as rolling elements, or a trough-shaped track for balls as rolling elements. This, for instance, makes it possible to produce a spindle and/or a nut for a roller screw drive, such as a ball screw drive, for example.

The present invention also provides for the high-pressure deformation, also known as hydroforming, of a pipe in order to produce a course of thread. For the deforming, the pipe is placed in a tubular shaping tool, whose inner surface is provided with a negative matrix of the course of thread, whereupon high pressure is applied from the inside. Or a shaping tool having a negative matrix of the course of thread on the outer periphery is inserted in the pipe, and pressure is applied to the pipe from the outside. In both cases the pipe wall is integrally molded on the negative matrix of the course of thread of the shaping tool, so that the pipe wall is plastically deformed and provided with the course of thread in the process. Preferably, a tubular shaping tool having the negative matrix of the course of thread on the inner peripheral area is used for an outer thread of the threaded part, and a shaping tool having the negative matrix of the course of thread on the outer periphery is used for an internal thread of the course of thread.

The present invention also provides for the mechanical deformation of a pipe in order to produce the course of thread. Examples of mechanical deformation methods for producing a course of thread are thread rolling, thread grooving, thread bulging and rotary swaging. These deformation methods are known per se and need no further explanation. The enumeration is meant as an example and is not all-inclusive.

The present invention also provides for the production of a course of thread from a strip, such as a sheet metal strip. This strip is reshaped, preferably using a throughfeed method, in order to form a thread profile of the course of thread; for example, it is shaped in the form of a trough which forms a track for balls as rolling elements, and the strip is deformed into a spindle in the form of a helix of the course of thread. The sequence of the method steps may be reversed, but in most cases it would be advantageous to first form the thread profile and then to form the strip in the shape of a spindle. A simultaneous execution of both deformation steps is conceivable as well.

The present invention also provides a roller screw drive, e.g., a ball screw drive, having a spindle, a nut, and rolling elements such as balls. The spindle and/or the nut are/is produced using the method of the present invention which has been described herein.

The present invention also provides a linear actuator which has an electric motor and a ball screw drive as described herein. The linear actuator converts a rotary drive motion of the electric motor into a translatory output motion. The electric motor is developed as quill drive, and its hollow shaft has a nut or a hollow spindle which is produced by the method of the present invention. The nut or the hollow spindle form a rotatable drive component of the ball screw drive. The hollow spindle has an internal thread, and the course of thread is situated on the inside.

The present invention also provides an electromechanical brake booster having a linear actuator as described herein.

Exemplary embodiments of the present invention are described in greater detail below with reference to the accompanying drawings.

### BRIEF DESCRIPTION OF THE DRAWINGS

FIG. 1 shows an electromechanical brake booster according to the present invention.

FIG. 2 shows the production of a course of thread by high-pressure deformation according to the present invention.

FIG. 3 shows the production of a course of thread by thread bulging according to the present invention.

FIG. 4 shows the production of a course of thread by rotary swaging according to the present invention.

FIG. 5 shows the production of a course of thread by thread grooving according to the present invention.

FIG. 5a shows a cross-section of a thread groover of FIG. 5.

FIGS. 6 and 7 show two hollow spindles produced according to the method of the present invention.

The figures are merely simplified and sketched illustrations to explain the present invention for better understanding.

### DETAILED DESCRIPTION

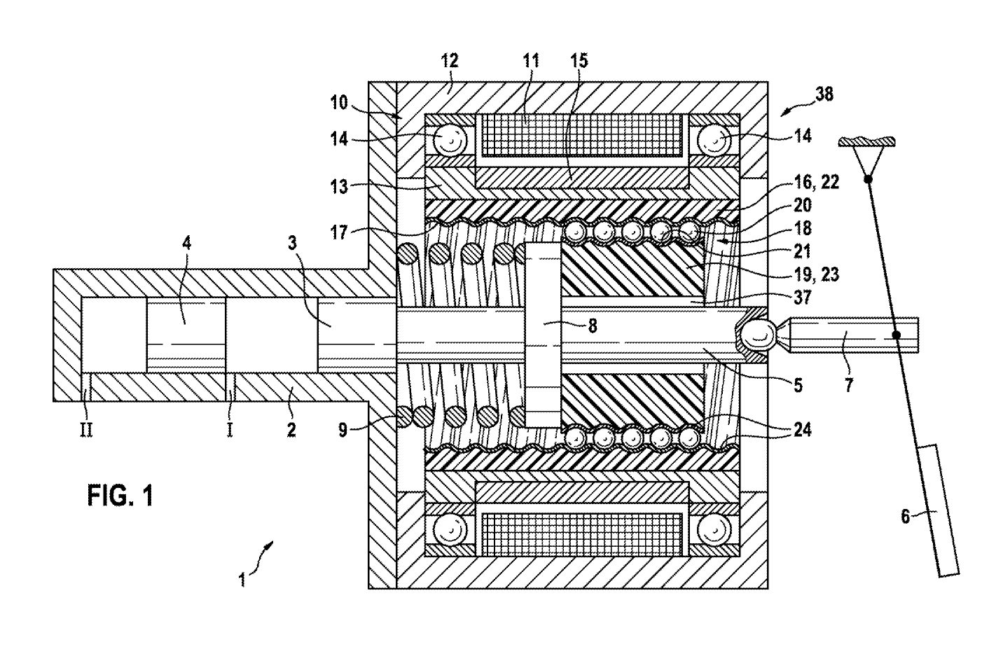

Electromechanical brake booster 1 according to the present invention as shown in FIG. 1 is flange-mounted on a two-circuit master brake cylinder 2, which is provided with connections I, II for two brake circuits of a hydraulic vehicle brake system (not shown); in the known manner, it is also provided with a rod piston 3 and a floating piston 4. Brake booster 1 has a push rod 5, which is axially displaceable via a pedal rod 7 in order to actuate the brake using a brake pedal. Push rod 5 rests against rod piston 3, and shifts rod piston 3 in master brake cylinder 2 when brake pedal 6 is depressed, so that hydraulic pressure for actuating a (not illustrated) vehicle system connected to master brake cylinder 2 is able to be generated in a manner known per se. The pressure generated by rod piston 3 acts on floating piston 4, so that this piston, too, generates pressure in a second brake circuit.

A perforated disk as driver pin 8 is permanently mounted on push rod 5. Situated on the master brake cylinder-side of driver pin 8 is a helical compression spring as restoring spring 9, which returns push rod 5 to its initial position when brake pedal 6 is released.

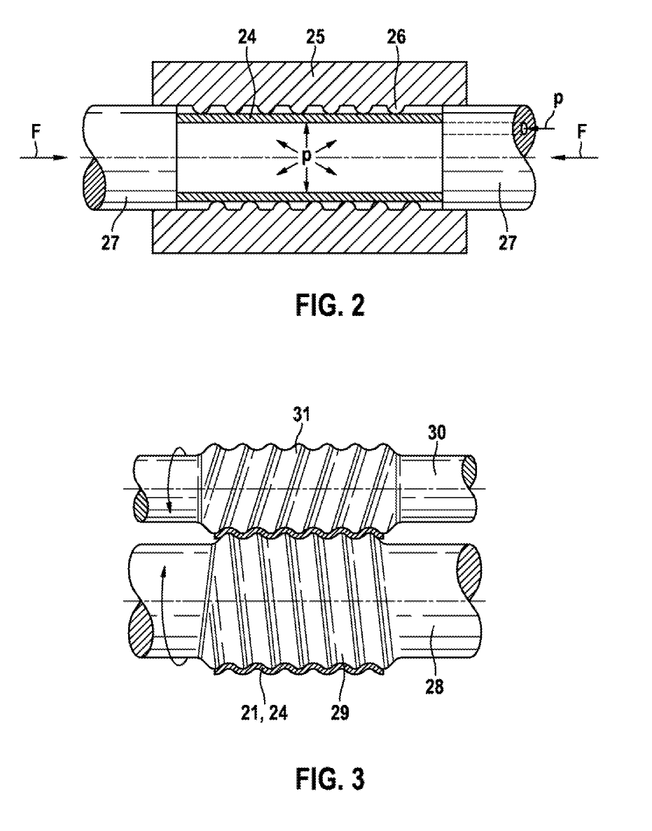

Brake booster 1 has an electric motor 10, which is developed as quill motor and concentrically encloses push rod 5. Electric motor 10 has stator windings 11 in an engine housing 12. A tubular rotor 13 is rotably mounted in engine housing 12 with the aid of ball bearings 14. Rotor 13 includes permanent magnets 15 and a hollow spindle 16 having an internal thread 17. Hollow spindle 16 is both the engine shaft of electric quill motor 10 and part of a roller screw drive, which is developed as ball-screw drive 18 in the exemplary embodiment of the present invention shown; in addition to hollow spindle 16, it has a hollow screw 19 and balls 20 as rolling elements. Hollow screw 19 has an axial through hole 37, which is penetrated by push rod 5 of brake booster 1. Hollow screw 19 concentrically encloses push rod 5 and is disposed in hollow spindle 16 and electric motor 10 in concentric manner. Balls 20 are rolling in a course of thread 17 of hollow spindle 16 and in a course of thread 21 of hollow screw 19. Ball screw drive 18 converts a rotary drive motion of electric motor 10 into a translatory output motion of hollow screw 19 which rests against driver pin 8 of push rod 5 and displaces rod piston 3 of master brake cylinder 2 via driver pin 8 and push rod 5. In this way a supplementary force of brake booster 1 is coupled in and amplifies the actuating force that is applied via brake pedal 6 and acts on rod piston 3. Ball screw drive 18 has a ball return system, which is known per se and not visible in the drawing. Hollow spindle 16 and hollow screw 19, too, may be considered threaded parts 16, 19 of ball screw drive 18. Their production is explained below with reference to FIGS. 2 through 7.

Electric motor 10, designed as quill motor, and ball screw drive 18 form a linear actuator 38 according to the present invention, which may be used to generate a linear output motion, i.e., the displacement of push rod 5. Uses of linear actuator 38 other than as brake booster are possible as well.

Hollow spindle 16 has a course of thread 17 on the inside, and hollow screw 19 has course of thread 21 on the outside. Courses of thread 17, 21 extend in the form of spirals, i.e., helices, and are produced from wear-resistant materials, such as metal in the illustrated exemplary embodiments; they have a trough-shaped cross-section as tracks for balls 20. Both threaded parts 16, 19 have tubular supporting structures 22, 23, on whose inner or outer circumference they are fixed in place and which give stability to courses of thread 17, 21. In the illustrated exemplary embodiments of the present invention, supporting structures 22, 23 are made of plastic and produced by primary shaping, e.g., by injection molding.

Threaded parts 16, 19, i.e., hollow spindle 16 and hollow screw 19, are composite components, which are made up of supporting structures 22, 23 and courses of thread 17, 21 joined to supporting structures 22, 23.

FIG. 2 shows the production of course of thread 21 of hollow screw 19 according to the present invention by high-pressure deformation, which is also known as hydroforming. In the process, a thin-walled metal pipe 24 is placed in a stable, tubular shaping tool 25, which has on its inner periphery a spiral- or helix-shaped protuberance 26 as negative matrix of course of thread 21. With the aid of locking dies 27, pipe 24 is hermetically sealed at both face ends, whereupon high pressure is applied hydraulically from the inside. In this manner pipe 24 forms on helix-shaped protuberance 26 of shaping tool 25 and is provided with course of thread 21. Because pipe 24 becomes axially slightly shorter as a result of the undulation during the deformation process, more stress is applied on locking dies 27. Following the deformation process, pipe 24, which now has course of thread 21, is able to be unscrewed from shaping tool 25, because it elastically contracts to some extent following the end of the pressure application and thus lies loosely inside shaping tool 25.

After the high-pressure deformation, pipe 24 is placed in an injection-molding die (not illustrated) and tubular supporting structure 23 is produced from plastic by an injection molding process, that is to say, by a primary shaping process. Simultaneously with its production by primary shaping, supporting structure 23 is joined to pipe 24 having course of thread 21, so that hollow screw 19 is formed, which constitutes a threaded part of ball screw drive 18. Hollow screw 19 forming the threaded part thus is a composite component, which has course of thread 21 produced by the high-pressure deformation process, and tubular supporting structure 23 produced by primary shaping.

In the same way as course of thread 21 of hollow screw 19, course of thread 17 of hollow spindle 16 is also able to be produced via high-pressure deformation. In this case, a rod-shaped shaping tool provided with a spiral-shaped or helix-shaped protuberance as negative matrix of course of thread 17, is situated within the pipe to be deformed. High pressure is applied to the pipe from the outside, for which purpose it is placed in a pressure-resistant, tubular housing (not shown). After course of thread 17 has been formed, the pipe having tubular supporting structure 22 made of plastic is extrusion-coated, so that hollow spindle 16 is produced as composite component together with tubular supporting structure 22 and course of thread 17, which is formed in one piece with supporting structure 22.

FIGS. 3 through 7 show courses of thread 17, 21 which have been produced by mechanical deformation. FIG. 3 shows the production of course of thread 21 by thread spinning. For this purpose, pipe 24 is placed on a rotatable shaping tool 28 provided with a shaping surface 29 in the form of course of thread 21. A counter-rotating roller 30 having a complementary shaping surface 31 exerts pressure on pipe 21 from the outside and thereby produces course of thread 21. Course of thread 17 of hollow spindle 16 is able to be produced in the same way. After course of thread 21 or 17 has been produced, pipe 24 is placed in an injection die, and supporting structure 23 or 22 is produced from plastic by injection molding, as it was described in connection with FIG. 2. Here, too, the threaded part, i.e., hollow screw 19 or hollow spindle 16, has been produced as composite component together with course of thread 21, 17 and tubular supporting structure 23, 22.

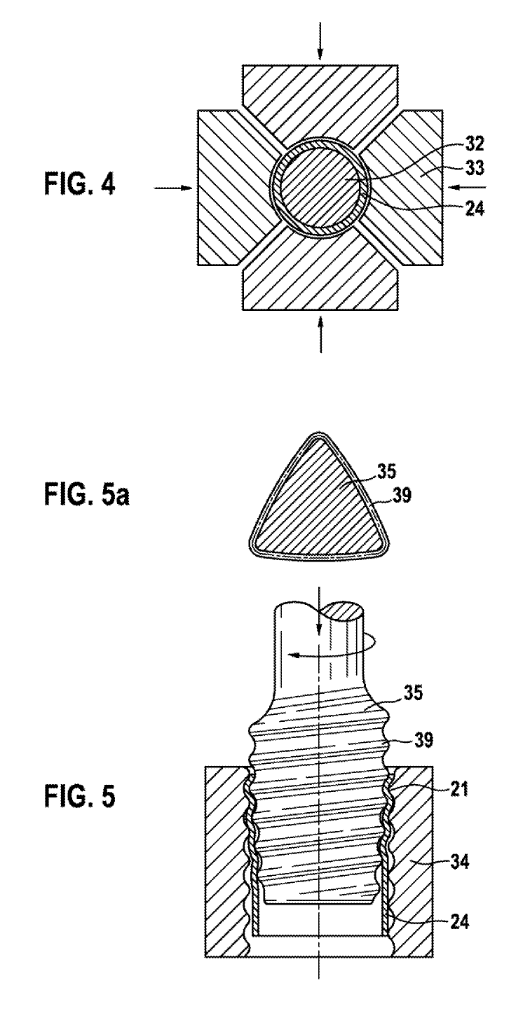

FIG. 4 shows the production of the course of thread from thin-walled pipe 24 by means of swaging. In this case, pipe 24 is situated on a shaping tool 32, whose peripheral surface as shaping surface has a form that corresponds to course of thread 17 or 21. Radially movable swage jaws 33, which are provided with negative matrices of course of thread 17 or 21 on their end faces pointing toward pipe 24, form course of thread 17 and 21. Swage jaws 33 may extend across the length of pipe 24 or course of thread 17 and 21, or they are axially offset in order to form course of thread 17, 21 in multiple steps. It is also possible to rotate shaping tool 32 having pipe 24 in relation to swage jaws 33 when swage jaws 33 are open, so that swage jaws 33 are acting on pipe 24 step by step in a manner that is offset in the circumferential direction. Here, too, supporting structure 22, 23 is produced by injection molding from plastic once course of thread 17 or 21 has been obtained with the aid of a deformation process, thereby resulting in the production of the threaded part as composite component made up of course of thread 17, 21 and supporting structure 22, 23.

FIG. 5 shows the production of course of thread 21 with the aid of thread forming. In this case, a thread former 35 is introduced into pipe 24 using a screwing motion, i.e., in rotating manner, with simultaneous axial forward feeding.

Because pipe 24 has thin walls, it is supported during the reshaping operation by a tubular shaping tool 34 whose inner periphery has a shape that corresponds to course of thread 21. Thread former 35 has roughly the form of a truncated pyramid, but instead of edges, it is provided with rounded regions, and the side surfaces are convex. FIG. 5a shows a cross-section of thread former 35. Thread former 35 has corrugations 39 which correspond to course of thread 21, so that course of thread 21 is able to be formed. Course of thread 17 of hollow spindle 16 can be produced in a similar manner through a thread forming process. Here, too, supporting structures 22, 23 are produced by injection molding from plastic once courses of thread 17, 21 have been formed.

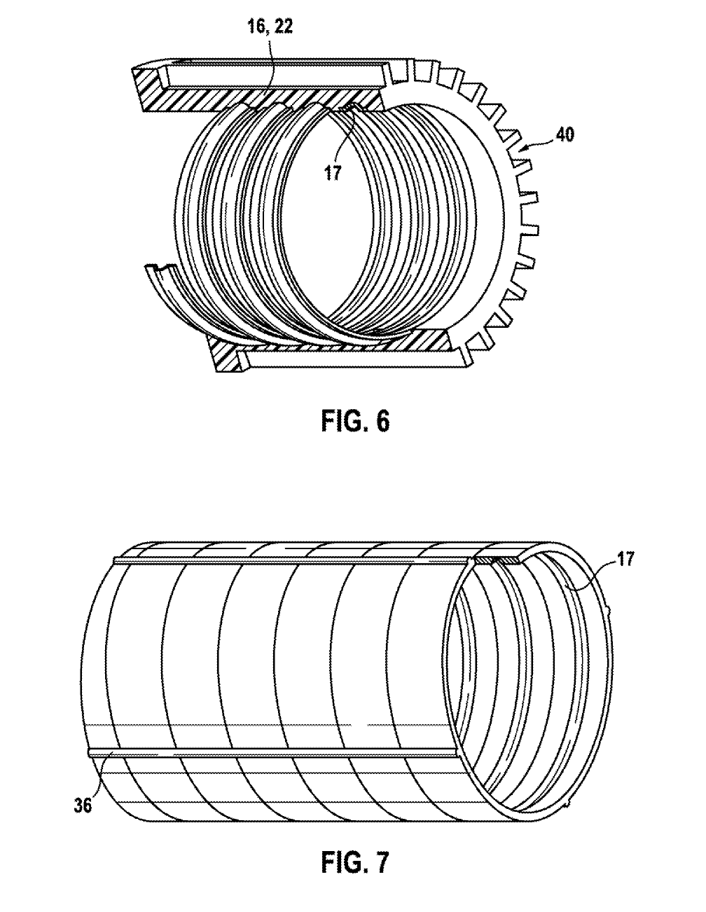

FIG. 6 shows a hollow spindle 16, whose course of thread 17 is produced by roll-forming, from a sheet metal strip which originally had a rectangular cross-section. The roll-forming gives the sheet metal strip a trough-shaped profile, as shown in FIG. 6. The sheet metal strip then is reshaped in the form of a spiral or helix in order to obtain course of thread 17, whereupon it is extrusion-coated in an injection-molding die (not shown) together with tubular supporting structure 22 made of plastic. As in all developments of hollow spindle 16, supporting structure 22 has pockets 40 to accommodate permanent magnets 15 of rotor 13.

In FIG. 7 as well, course of thread 17 is produced from a sheet metal strip having a flat, rectangular cross-section. A trough-shaped indentation, which forms course of thread 17, is impressed in the sheet metal strip. Then, the sheet metal strip is bent in spiral shape to form a pipe, its longitudinal edges resting against each other, as can be gathered from FIG. 7. The coils of the sheet metal strip are joined to each other to form the pipe, which then is extrusion-coated together with the supporting structure 22 made of plastic; the joining, for example, is accomplished by spot welding as shown in FIG. 7, by welding seams 36 that extend in the longitudinal direction, or by a spiral-shaped welding seam along the abutting longitudinal edges of the sheet metal strip (not shown).

1-10. (canceled)

11. A method for producing a threaded part as composite component, comprising:
producing a course of thread by deformation, and
joining the course of thread to a supporting structure,
wherein the supporting structure is produced by primary shaping, and the supporting structure is simultaneously also joined to the course of thread through the primary shaping of the supporting structure.

12. The method according to claim 11, wherein the supporting structure is tubular.

13. The method according to claim 11, wherein the course of thread has a track for rolling elements.

14. The method according to claim 11, wherein the course of thread is produced from a pipe by high-pressure deformation.

15. The method according to claim 11, wherein the course of thread is produced from a pipe by mechanical deformation.

16. The method according to claim 11, wherein the course of thread is produced from a strip, which is deformed into a thread profile of the course of thread and into a spindle.

17. A ball screw drive, comprising:
a spindle,
a spindle counterpart, and
rolling elements which roll in courses of thread of the spindle and the spindle counterpart, the spindle and/or the spindle counterpart being produced as composite components each having a course of thread obtained by deformation and a tubular supporting structure, each supporting structure being joined to a respective course of thread to form the composite components,
wherein each supporting structure is produced by primary shaping and each supporting structure is simultaneously also joined to the respective course of thread through the primary shaping.

18. The ball screw drive according to claim 17, wherein the ball screw drive includes a hollow spindle.

19. A linear actuator, comprising:
an electric motor, and
a ball screw drive which converts a rotary motion of the electric motor into a translatory motion, the electric motor being developed as quill motor whose hollow shaft is formed by a hollow spindle of the ball screw drive, the hollow spindle and/or a spindle counterpart of the ball screw drive being produced as composite components each having a course of thread produced by deformation and a tubular supporting structure, each supporting structure being joined to a respective course of thread to form the composite components,
wherein each supporting structure is produced by primary shaping and is simultaneously also joined to the respective course of thread through the primary shaping.

20. An electromechanical brake booster, comprising:
an electric motor, and
a ball screw drive which converts a rotary motion of the electric motor into a translatory motion, the electric motor being developed as quill motor, whose hollow shaft is formed by a hollow spindle of the ball screw drive, the hollow spindle and/or a spindle counterpart of the ball screw drive being produced as composite components each having a course of thread produced by deformation and a tubular supporting structure, each supporting structure being joined to a respective course of thread to form the composite components,
wherein each supporting structure is produced by primary shaping and is simultaneously also joined to the respective course of thread through the primary shaping.
